(19) United States
(12) Patent Application Publication
(10) Pub. No.: US 2021/0026701 A1
(43) Pub. Date: Jan. 28, 2021

(54) COMPUTER-IMPLEMENTED METHOD AND APPARATUS FOR PLANNING RESOURCES

(71) Applicant: Robert Bosch GmbH, Stuttgart (DE)

(72) Inventors: Arne Hamann, Ludwigsburg (DE); Dakshina Narahari Dasari, Boeblingen (DE); Holger Broede, Sachsenheim (DE); Michael Pressler, Karlsruhe (DE)

(21) Appl. No.: 16/893,336

(22) Filed: Jun. 4, 2020

(30) Foreign Application Priority Data
Jul. 25, 2019 (DE) 102019211075.4
May 6, 2020 (DE) 102020205720.6

(51) Int. Cl. G06F 9/50; G06F 9/455

(52) U.S. Cl. CPC G06F 9/5066; G06F 9/5038; G06F 2009/45583; G06F 9/45558; G06F 2009/4557; G06F 9/5083

(57) ABSTRACT

A computer-implemented method for planning resources, in particular computing-time resources, of a computing device having at least one computing core, for execution of tasks. the method includes the following steps: furnishing a plurality of containers, a priority being associatable or associated with each container; associating at least one task with at least one of the containers; and associating each container with the at least one computing core.

### CROSS REFERENCE

The present application claims the benefit under 35 U.S.C. § 119 of German Patent Application Nos. 102019211075.4 filed on Jul. 25, 2019, and 102020205720.6 filed on May 6, 2020, which are each expressly incorporated herein by reference in its entirety.

### FIELD

The present invention relates to a computer-implemented method for planning resources, in particular computing-time resources, of a computing device having at least one computing core, for execution of tasks.

The present invention further relates to an apparatus for planning resources, in particular computing-time resources, of a computing device having at least one computing core, for execution of tasks.

### SUMMARY

Preferred example embodiments of the present invention include a computer-implemented method for planning resources, in particular computing-time resources, of a computing device having at least one computing core, for execution of tasks, having the following steps: furnishing a plurality of containers, a priority being associatable or associated with each container; associating at least one task with at least one of the containers; associating each container with a computing core of the several computing cores. This makes it possible, for instance, to furnish a flexible, resource-aware scheduling system, i.e., a system for planning tasks for execution by the computing device, in which system, for instance, run-time guarantees can advantageously also be given.

Aspects of the preferred embodiments of the present invention can be used, for example, in a control device, for instance for an internal combustion engine of a motor vehicle, in particular for efficient and flexible task scheduling, but are not limited to that field of application. Aspects of the preferred embodiments of the present invention can furthermore preferably also be used, for example, in so-called advanced driver assistance systems.

In further preferred embodiments of the present invention, the computing device has more than one computing core.

“Tasks” will be used hereinafter as a unit for plannable or schedulable and executable software (e.g., in the form of a computer program or parts thereof); in further preferred embodiments of the present invention, planning can be effected, for instance, by a scheduler or a scheduling system that is embodied to execute the method according to the embodiments. In further preferred embodiments, “tasks” can also represent complete subsystems, e.g., virtual machines.

In further preferred embodiments of the present invention, provision is made that at least one of the containers, preferably each of the containers, has associated with it an, in particular static, priority; this enables efficient priority control.

In further preferred embodiments of the present invention, provision is made that at least one of the containers, preferably each of the containers, has a resource budget associated with it, the resource budget in particular characterizing resources, in particular computing-time resources, for tasks associated with the container or with the respective container. The available computing-time resources of the computing device can thereby be flexibly distributed among various containers. In further preferred embodiments, for instance, various containers each having different priorities, and identical or similar or different quantities of computing-time resources, can thus also be provided.

In further preferred embodiments of the present invention, each container is dimensioned or budgeted (see “resource budget” above) with regard to its guaranteed run time within a time period. In further preferred embodiments of the present invention, containers can be exclusively assigned to tasks. In further preferred embodiments, for example, the dimension of the container guarantees to a, or to that, task a run time for a previously defined time period.

In further preferred embodiments of the present invention, provision is made that at least one of the containers, preferably each of the containers, has a budget replenishment strategy associated with it. It is thereby possible, for example, for various containers to provide for a different replenishment of the resource budget; this further increases flexibility.

In further preferred embodiments of the present invention, provision is made that at least one of the containers, preferably each of the containers, has a budget replenishment strategy associated with it, the budget replenishment strategy in particular characterizing at least one of the following elements: a) a point in time of a replenishment of the resource budget associated with the container; b) an extent of a or the replenishment of the resource budget associated with the container.

In further preferred embodiments of the present invention, provision is made that the resource budget is replenished periodically and/or at, in particular statically, specified points in time and/or depending on other criteria, in particular depending on a previous consumption of resources, in particular computing-time resources, associated with the resource budget.

In further preferred embodiments of the present invention, provision is made that at least one of the containers, preferably each of the containers, has a budget retention strategy associated with it, the budget retention strategy in particular characterizing a behavior of the container with regard to a resource budget that is not, in particular immediately, used.

In further preferred embodiments of the present invention, provision is made that the budget retention strategy provides that a) the resource budget of the container expires at a or the point in time of a replenishment of the resource budget associated with the container, in particular provided no task is ready to use the resource budget associated with the container; and/or that b) the resource budget of the container continues to be reserved, in particular for tasks still arriving. Preferably, the resource budget of the container can continue to be reserved until a subsequent replenishment. It can then, also preferably, be replenished at the aforesaid replenishment, in particular up to a predefinable budget value but, also preferably, not beyond the predefinable budget value.

In further preferred embodiments of the present invention, provision is made that the method further encompasses: ascertaining, for each task that is ready, a respective first container having a not insignificant resource budget (or having a resource budget that exceeds a predefinable threshold value), with the result that ascertained first containers are obtained; selecting those ascertained first containers having the highest priority, with the result that a selected container is obtained, such that in particular when the selected container has been ascertained for several tasks, that task of the several tasks which has the highest priority is selected.

In further preferred embodiments of the present invention, provision is made that a corresponding task is ascertained for each computing core, in particular an execution of the corresponding task being caused or carried out.

In further preferred embodiments of the present invention, provision is made that at least one, preferably at least two, of the containers are each used as an, in particular static, slack pool, in particular the container having the highest priority being used as a first slack pool, and/or in particular the container having the lowest priority being used as a second slack pool.

The term “slack pool” is, in particular, from the field of real-time scheduling analysis. “Slack” often refers to the idle state of a system which can still be used productively elsewhere. The “pool” is a logical vessel or container in which unscheduled run time is bundled so that it can be used dynamically, preferably according to predefined criteria. The intention is thereby to ensure real-time behavior of the system.

In further preferred embodiments of the present invention, a “slack pool” can be construed as a way for characterizing and/or collecting and/or reserving and/or furnishing and/or organizing resources, in particular computing-time resources. In further preferred embodiments of the present invention, this functionality can be implemented, for instance, by way of at least one container according to the embodiments.

In further preferred embodiments of the present invention, a “slack pool” can be construed as a container that in particular does not serve to guarantee the actual run time of one or several tasks but instead can be used flexibly for one or several associated tasks that, in particular, require run time beyond their guaranteed time.

In further preferred embodiments of the present invention, “task slack” can be construed as a difference between a guaranteed and a required run time of one or several of those tasks.

In further preferred embodiments of the present invention, “system slack” can be construed as an emergency reserve for tasks that require run time beyond their guarantees. This system slack is preferably distributed over one or several slack pools.

In further preferred embodiments of the present invention, any number of slack pools or containers can be provided or used. In further preferred embodiments, for example, “only” one slack pool can also be provided.

In further preferred embodiments of the present invention, the slack pool can preferably be provided as a “backup” for overflowing functions or special cases in which, for instance, more than one previously guaranteed run time is unexpectedly required.

In further preferred embodiments of the present invention, a sequence in which tasks are executed is defined previously (e.g., in the context of a schedule, e.g., before activation of an apparatus executing the method).

In further preferred embodiments of the present invention, firstly (a) container(s) for furnishing resources is/are furnished, and also preferably the slack pool(s) is/are used as backup, in particular only when the aforesaid container has no further budget. Also preferably, access to the slack pool(s) occurs according to a predefinable prioritization.

In further preferred embodiments of the present invention, one or several slack pools can also be provided or used on several priority levels. In further preferred embodiments, slack pools can also be disposed hierarchically.

In further preferred embodiments of the present invention, provision is made that at least one task is associated with the first slack pool, in particular the at least one task being associated a) with at least one container other than the first slack pool, and b) additionally with the first slack pool. In further preferred embodiments, for instance, resources regularly required for execution of the relevant task can thereby be provided, for instance, in the at least other container and, if applicable, further resources necessary for execution of the relevant task can be taken from the first slack pool.

In further preferred embodiments of the present invention, provision is made that at least one task is associated, for instance, with the second slack pool, in particular the at least one task being associated a) with at least one container other than the second slack pool, and b) additionally with the second slack pool. This further increases the flexibility with which tasks are planned and/or executed.

In further preferred embodiments of the present invention, provision is made that at least one task is associated, for instance, only with the first slack pool or with the second slack pool. In further preferred embodiments, provision is made that at least one task is associated with several slack pools.

In further preferred embodiments of the present invention, provision is made that at least one task is associated with the first slack pool and with the second slack pool, and with at least one further container.

Further preferred embodiments of the present invention include an apparatus for executing the method as recited in at least one of the preceding claims. In further preferred embodiments of the present invention, the apparatus can be integrated into the computing device and/or a functionality of the apparatus can be implemented at least in part by the computing device. In further preferred embodiments, the apparatus can be used, for instance, to furnish a scheduling system.

Further preferred embodiments of the present invention include a computer program encompassing instructions that, upon execution of the program by a computer, cause the latter to execute the method or the steps of the method according to the embodiments.

Further preferred embodiments of the present invention include a computer-readable storage medium encompassing instructions that, upon execution by a computer, cause the latter to execute the method or the steps of the method according to the embodiments.

Further preferred embodiments of the present invention include a data carrier signal that transfers and/or characterizes the computer program according to the embodiments.

Further preferred embodiments of the present invention include a use of the method according to the embodiments and/or of the apparatus according to the embodiments and/or of the computer program according to the embodiments and/or of the data carrier signal according to the embodiments to plan computing-time resources of a computing device, in particular for an operating system for the computing device and/or for a hypervisor for controlling virtual machines. For example, the principle according to preferred embodiments can be utilized in a control device, for instance for an internal combustion engine of a motor vehicle.

Further features, potential applications, and advantages of the present invention are evident from the description below of exemplifying embodiments of the present invention which are depicted in the Figures. All features described or depicted in that context, individually or in any combination, constitute the subject matter of the invention, regardless of herein or in the igures.

### BRIEF DESCRIPTION OF THE DRAWINGS

FIG. 1 is a simplified schematic block diagram according to preferred embodiments of the present invention.

FIG. 2A is a simplified schematic flow chart of a method according to further preferred embodiments of the present invention.

FIG. 2B is a simplified schematic flow chart of a method according to further preferred embodiments of the present invention.

FIG. 2C is a simplified schematic flow chart of a method according to further preferred embodiments of the present invention.

FIG. 2D is a simplified schematic flow chart of a method according to further preferred embodiments of the present invention.

FIG. 3 is a simplified schematic flow chart of a method according to further preferred embodiments of the present invention.

FIG. 4 is a simplified schematic block diagram of an apparatus according to further preferred embodiments of the present invention.

FIG. 5 is a simplified schematic block diagram of a container according to further preferred embodiments of the present invention.

### DETAILED DESCRIPTION OF EXAMPLE EMBODIMENTS

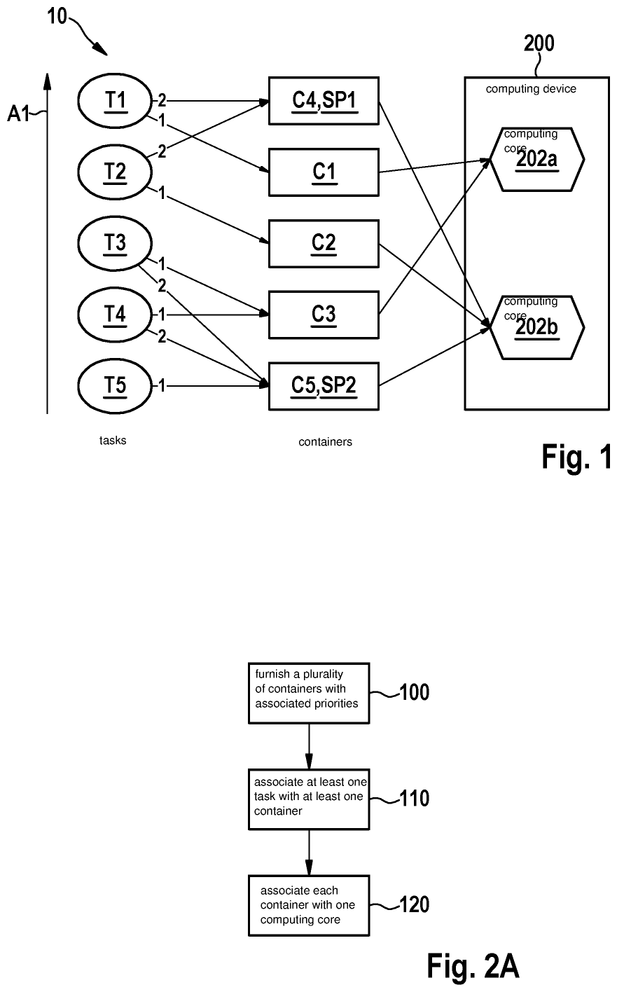

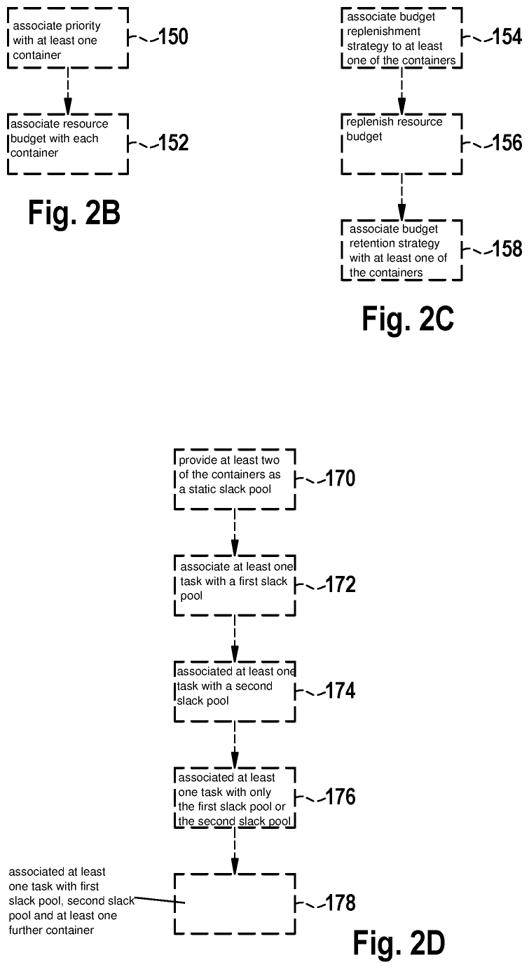

FIG. 1 is a simplified schematic block diagram of a scheduling system 10 according to preferred embodiments of the present invention. Scheduling system 10 can be furnished, for example, using a method, described below with reference to FIG. 2A, according to further preferred embodiments of the present invention.

Further preferred embodiments include a computer-implemented method for planning resources, in particular computing-time resources, of a computing device 200 having several computing cores 202a, 202b (FIG. 1), for execution of tasks T1, . . . , T5, having the following steps (see FIG. 2A): furnishing 100 a plurality of containers C1, C2, C3, C4, C5 (FIG. 1), a priority being associatable or associated with each container C1, C2, C3, C4, C5; associating 110 (FIG. 2A) at least one task T1, T2, T3, T4, T5 with at least one of containers C1, . . . , C5; associating 120 (FIG. 2A) each container C1, . . . , C5 with, in particular exactly, one computing core 202a, 202b (FIG. 1) of the several computing cores. This makes it possible, for instance, to furnish a flexible, resource-aware scheduling system 10, i.e., a system for planning tasks for execution by computing device 200.

In the present instance five tasks, e.g., tasks T1, T2, T3, T4, T5, are depicted by way of example in FIG. 1; arrow Al pointing vertically upward in FIG. 1 indicates a vertically upwardly increasing priority of tasks T1, . . . , T5. Optionally, arrow A1 can also indicate a vertically upwardly increasing priority of containers C1, . . . , C5 (see below). “Tasks” will be used hereinafter as a unit for plannable or schedulable and executable software (e.g., in the form of a computer program); in further preferred embodiments, the planning can be effected, for instance, by a scheduler or a scheduling system 10 that is embodied to execute the method according to the embodiments. In further preferred embodiments, “tasks” can also represent complete subsystems, e.g., virtual machines.

In further preferred embodiments of the present invention, provision is made that at least one of the containers, preferably each of the containers C1, . . . , C5, has an, in particular static, priority associated with it (see optional step 150 of FIG. 2B); this enables efficient priority control.

In further preferred embodiments of the present invention, provision is made that at least one of the containers, preferably each of containers C1, . . . , C5, has a resource budget associated with it (see optional step 152 of FIG. 2B); in particular, the resource budget characterizes resources, in particular computing-time resources, for tasks associated with the container or with the respective container. The computing-time resources of computing device 200 (FIG. 1) which are available can thereby be flexibly distributed among different containers. In further preferred embodiments, for instance, different containers can thus also be provided with respectively different priorities and with identical or similar or different quantities of computing-time resources.

In further preferred embodiments of the present invention, each container C1, . . . , C5 is dimensioned or budgeted (see “resource budget” above) with regard to its guaranteed run time within a time period. In further preferred embodiments, containers can be exclusively assigned to tasks. In further preferred embodiments, for example, the dimension of the container guarantees to a, or to that, task a run time for a previously defined time period.

In further preferred embodiments of the present invention, provision is made that at least one of the containers, preferably each of containers C1, . . . , C5, has a budget replenishment strategy associated with it (see optional step 154 of FIG. 2C). This makes it possible, for instance, to provide a different replenishment of the resource budget for various containers; this further enhances flexibility.

In further preferred embodiments of the present invention, provision is made that at least one of the containers, preferably each of containers C1, . . . , C5, has a budget replenishment strategy associated with it, the budget replenishment strategy in particular characterizing at least one of the following elements: a) a point in time of a replenishment of the resource budget associated with the container; b) an extent of a or the replenishment of the resource budget associated with the container.

In further preferred embodiments of the present invention, provision is made that the resource budget is replenished periodically and/or at, in particular statically, specified points in time and/or depending on other criteria, in particular depending on a previous consumption of resources, in particular computing-time resources, associated with the resource budget (see optional step 156 of FIG. 2C).

In further preferred embodiments of the present invention, provision is made that at least one of the containers, preferably each of containers C1, . . . , C5, has a budget retention strategy associated with it (see optional step 158 of FIG. 2C), the budget retention strategy in particular characterizing a behavior of the container with regard to a resource budget that is not, in particular immediately, used.

In further preferred embodiments of the present invention, provision is made that the budget retention strategy provides that a) the resource budget of the container expires at a or the point in time of a replenishment of the resource budget associated with the container, in particular provided no task T1, . . . , T5 is ready to use the resource budget associated with the container; and/or that b) the resource budget of the container continues to be reserved, in particular for tasks still arriving. In further preferred embodiments, the unused budget expires at the point in time of replenishment.

Preferably, filling occurs, in particular always, at a or the above-defined time budget.

The structure of scheduling system 10 depicted by way of example in FIG. 1 will be described below in accordance with further preferred embodiments of the present invention. Each task T1, . . . , T5 is associated with one or several containers C1, . . . , C5 that, in further preferred embodiments, can also be referred to as “scheduling containers.” In further preferred embodiments, the sequence of the scheduling containers is represented, for instance, in an ordered list, in particular represented for each task T1, . . . , T5. The number at the edge from the task to the container preferably specifies the position in the list. According to FIG. 1, for example, task T1 is associated with container C1 and with container C4, the number “1” on the connecting line (“edge”) between task T1 and container C1 indicating that container C1 is in first place in the aforementioned ordered list, and the number “2” on the connecting line (“edge”) between task T1 and container C4 indicating that container C4 is in second place in the aforementioned ordered list.

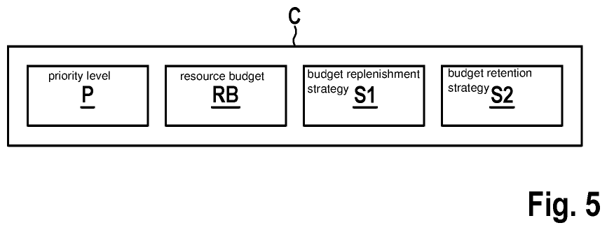

As already mentioned above, in further preferred embodiments of the present invention, each scheduling container C1, . . . , C5 is represented on “only” (i.e., exactly) one processor core 202a, 202b. According to further preferred embodiments of the present invention, each scheduling container C1, . . . , C5 is characterized by the following attributes (see also the schematic depiction of a container C in FIG. 5): a priority P, a resource budget RB (see also step 152 of FIG. 2B), a budget replenishment strategy S1 (see also step 154 of FIG. 2B), a budget retention strategy S2 (see also step 158 of FIG. 2B). In other words, in further preferred embodiments all containers C1, . . . , C5 of FIG. 1 can have structure C of FIG. 5.

In further preferred embodiments of the present invention, depending on the algorithms used there are differences, for instance, both in budget retention and in budget filling. These are in some cases subtle, but in further preferred embodiments of the present invention can also be combined with the principle according to the embodiments.

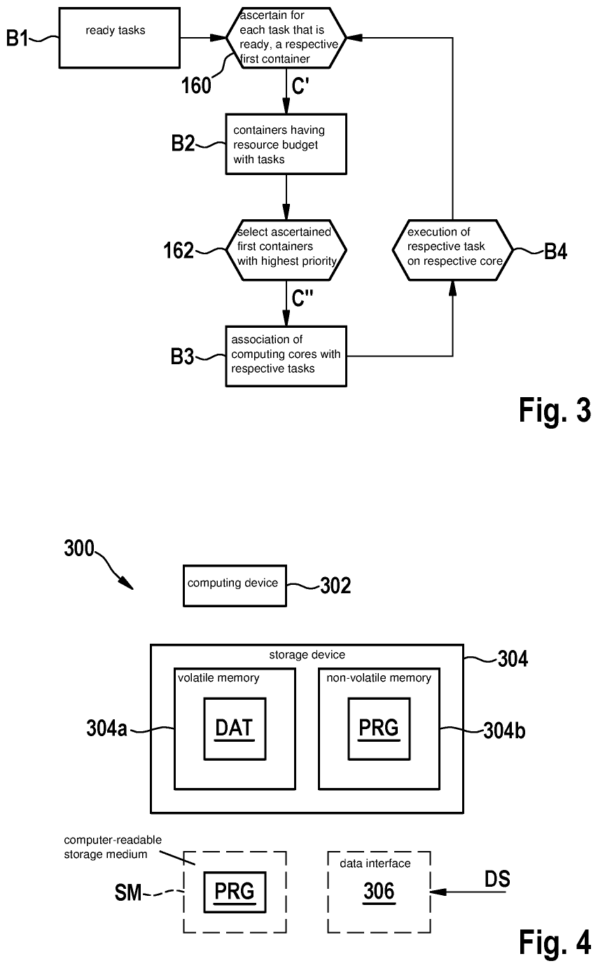

In further preferred embodiments (see FIG. 3) of the present invention, provision is made that the method further encompasses: ascertaining 160, for each task that is ready (by way of example, block B1 of FIG. 3 symbolizes all tasks T1, T2, T3, T4, T5 currently ready for execution), a respective first container having a not insignificant resource budget RB (FIG. 5), with the result that ascertained first containers C′ are obtained; selecting 162 those ascertained first containers C′ having the highest priority, with the result that a selected container C″ is obtained, such that in particular when the selected container has been ascertained for several tasks, that task of the several tasks which has the highest priority is selected. Block B2 represents an exemplifying association of containers having a resource budget with tasks, according to step 160, e.g., in the form [C1, T1], [C2, T2], [C3, T4], i.e., first task T1 being associated with first container C1, second task T2 with second container C2, and fourth task T4 with third container C3. Block B3 represents an exemplifying association of computing cores 202a, 202b (FIG. 1) with the respective tasks, and block B4 (FIG. 3) an execution of the respective task on the respective core. In further preferred embodiments, provision is made that a corresponding task is ascertained for each computing core, in particular an execution of the corresponding task being authorized or carried out (see block 4). Also preferably, the operation shown by way of example in FIG. 3 is repeated, in particular in event-controlled fashion (e.g., new task is added) and/or periodically.

In further preferred embodiments (see FIG. 2D) of the present invention, provision is made that, for instance, at least two of the containers are each used as an, in particular static, slack pool (see step 170), in particular, for instance, container C4 (FIG. 1) having the highest priority (see arrow A1, which also indicates the priority of containers C1, . . . , C5) being used as a first slack pool SP1, and/or in particular, for instance, container C5 having the lowest priority being used as a second slack pool SP2.

In further preferred embodiments of the present invention, a number of slack pools and/or a prioritization in the context of access thereto is configurable flexibly, if applicable, in particular, also dynamically (at run time).

In further preferred embodiments of the present invention, a “slack pool” can be construed as a means for characterizing and/or collecting and/or reserving and/or organizing resources, in particular computing-time resources. In further preferred embodiments of the present invention, this functionality can be implemented, for instance, by way of at least one container C4, C5 according to the embodiments.

In further preferred embodiments of the present invention, provision is made that at least one task Tl is associated with first slack pool SP1 (see the “edge” from task Tl to first slack pool SP1 of FIG. 1) (see step 172 of FIG. 2D), in particular the at least one task T1 being associated a) with at least one container C1 other than first slack pool SP1, and b) additionally with first slack pool SP1. In further preferred embodiments, for instance, resources regularly required for execution of the relevant task T1 can be provided, for instance, in the at least other container C1 and, if applicable, further resources necessary for execution of the relevant task can be taken from first slack pool SP1.

In further preferred embodiments of the present invention, at least one task is associated with a slack pool. Possible overflows of the relevant task can thereby, if applicable, be absorbed by the associated slack pool.

In further preferred embodiments of the present invention, provision is made that at least one task T3, T4 is associated with second slack pool SP2 (see step 174 of FIG. 2D), in particular the at least one task T3, T4 being associated a) with at least one container C2, C3 other than second slack pool SP2, and b) additionally with second slack pool SP2. This further increases the flexibility with which tasks are planned and/or executed.

In further preferred embodiments of the present invention, provision is made that at least one task T5 is associated only with the first slack pool (not shown) or with second slack pool SP2 (see the connection or “edge” from task T5 to second slack pool SP2, and see step 176 of FIG. 2D).

In further preferred embodiments of the present invention, provision is made that at least one task is associated with the first slack pool and with the second slack pool, and with at least one further container (see step 178 of FIG. 2D).

In further preferred embodiments of the present invention, the steps of the operations described above with reference to the flow charts of FIGS. 2A, 2B, 2C, 2D, 3 can also be executed at least partly in a sequence other than the one shown by way of example, and/or at least partly overlappingly with one another in time, and/or, in particularly periodically, repeatedly.

Further advantageous aspects of the exemplifying scheduling system 10 of FIG. 1 according to further preferred embodiments of the present invention are described below.

Containers C4, C5 represent two static (priority-exhibiting) slack pools SP1, SP2, of which the first SP1 is scheduled in this example as a highest-priority container C4 and can make available budget (e.g., computing-time resources) to the two highest-priority tasks T1, T2 if the latter cannot manage with their “own” budget (e.g., from other containers C1, C2). This can be the case, for example, if the execution of that task is infrequently prolonged, or if the other containers C1, C2 that are associated with those tasks were dimensioned to be very small (e.g., in terms of the average run time). In further preferred embodiments, longer run times are thus absorbed by the shared, in particular static, first slack pool SP1. According to further preferred embodiments, the association of the highest priority with first slack pool SP1 advantageously ensures that such overflows are directly absorbed.

In further preferred embodiments of the present invention, the second, in particular likewise static, slack pool SP2 having the lowest priority in this example absorbs loads of task T3 and task T4 only if no higher-priority container C3 has a resource budget. In this case, by way of example, task T5 is assigned only to second slack pool SP2. It thus becomes active only if all other budgets are exhausted and if task T3 and task T4 are not ready to execute. At points in time at which task T3 and task T4 do not require budget, task T5, for example, can use the guaranteed run time of second slack pool SP2.

The particular flexibility according to preferred embodiments of the present invention is notable for the fact that, for instance, task T1 and task T2, for example, can additionally be assigned to second slack pool SP2. Even larger overflows of those important tasks T1, T2 can thus be absorbed at the expense of the less-important tasks T3, T4, T5, in order to ensure reliable execution of particularly critical tasks T1, T2.

Further preferred embodiments of the present invention include an apparatus 300 (FIG. 4) for executing the method. In further preferred embodiments, apparatus 300 can be integrated into computing device 200 of FIG. 1 and/or a functionality of apparatus 300 can be implemented at least in part by computing device 200. In other words, in further preferred embodiments computing device 200 can also be embodied, for instance by way of a computing core (not shown) provided separately for that purpose, to execute the method according to the embodiments. In further preferred embodiments, apparatus 300 (FIG. 4) can be used, for instance, to furnish a scheduling system 10 (FIG. 1).

Apparatus 300 (FIG. 4) has at least one computing device 302; and at least one storage device 304, associated with computing device 302, for at least temporary storage of a computer program PRG, computer program PRG being embodied in particular for controlling an operation of apparatus 300, e.g., for at least temporary execution of the method according to the embodiments.

In further preferred embodiments of the present invention, computing device 302 encompasses at least one of the following elements: a microprocessor, a microcontroller, a digital signal processor (DSP), a programmable logic module (e.g., field programmable gate array, FPGA), an application-specific integrated circuit (ASIC), a hardware circuit. In further preferred embodiments of the present invention, combinations thereof are also possible. In further preferred embodiments of the present invention, computing device 302 encompasses at least one computing core.

In further preferred embodiments of the present invention, storage device 304 encompasses at least one of the following elements: a volatile memory 304a, in particular a working memory (RAM); a nonvolatile memory 304b, in particular a flash EEPROM. Computer program PRG is preferably stored in nonvolatile memory 304b.

In further preferred embodiments of the present invention, data for the operation of scheduling system 10 (FIG. 1), e.g., parameters P, RB, S1, S2 (FIG. 5), etc. for one or several or all containers, and/or data DAT characterizing the associations between tasks and/or containers and/or between containers and computing cores, etc. can be at least temporarily stored in storage device 304.

Further preferred embodiments of the present invention include a computer program PRG encompassing instructions that, upon execution of the program by a computer, cause the latter to execute the method or the steps of the method according to the embodiments.

Further preferred embodiments of the present invention include a computer-readable storage medium SM encompassing instructions, for instance in the form of computer program PRG, which, upon execution by a computer, cause the latter to execute the method or the steps of the method according to the embodiments.

Further preferred embodiments of the present invention include a data carrier signal DS that transfers and/or characterizes computer program PRG according to the embodiments. By way of data carrier signal DS, computer program PRG can be transferred, for example, from an external unit (not shown) to apparatus 300. Apparatus 300 can have, for instance, a preferably bidirectional data interface 306, inter alia for reception of data carrier signal DS.

Further preferred embodiments of the present invention include a use of the method according to the embodiments and/or of apparatus 300 according to the embodiments and/or of computer program PRG according to the embodiments and/or of data carrier signal DS according to the embodiments to plan computing-time resources of a computing device 200 (FIG. 1), in particular for an operating system for computing device 200 and/or for a hypervisor for controlling virtual machines.

The principle according to the embodiments of the present invention makes it possible to efficiently dimension (for the average case) budgets for resources such as computing-time resources of computing device 200, and to absorb overflows, for instance, using slack pools SP1, SP2, with the result that real-time properties can advantageously be offered or guaranteed.

The principle according to the embodiments of the present invention furthermore makes possible a clear hierarchization of (resource) budgets RB (FIG. 5) on various priority levels P, A1 which advantageously can be flexibly assigned on a container level. A clear definition is provided, for instance, in any dynamic situation, as to which task will be executed with which budget, and anomalous behavior that can occur with conventional approaches is ruled out.

The principle according to preferred embodiments of the present invention is furthermore entirely predictable, and enables explicit and targeted assignment, for instance, of excess system resources.

Further advantages and aspects that can occur at least at times in the context of at least some preferred embodiments of the present invention recited below.
a) Resource budgets permanently assigned to exclusive containers can be dimensioned more optimistically in the vicinity of the average run time of the respective task(s). Occasional run-time overflows can be systematically and correctly absorbed by “slack pools” SP1, SP2.
b) The advantages of dynamic and efficient scheduling are thereby combined with analytical predictability.
c) Precise control of system resources, especially in order to absorb overflows on multiple levels.
d) Capability for more efficient and more reliable execution of a mix of critical software with, for instance, hard, soft, and weakly-hard real-time requirements together with best-effort software on one shared hardware platform 200.
e) More efficient and more reliable handling of sporadic and real-time-critical software in an otherwise periodic system 10.
f) More efficient and more reliable handling of software having highly variable run-time requirements in a real-time system.
g) Makes possible an efficient and reliable system for systematic utilization of run-time slack in order to remain, despite poorly predictable boundary cases in system execution, in a system state that is correct in real-time terms.

The principle according to preferred embodiments of the present invention can be used, for instance, for operating-system schedulers that plan tasks of a computing device 200, but is not limited to that application. Further areas of application according to further preferred embodiments are hypervisor systems having scheduling methods for virtual machines (VMs), where the VM is scheduled, for instance, analogously to task T1, . . . , T5. In this case a VM is ready to run if a task within the VM is ready. In this case the particular task that uses up the budget of the VM would be irrelevant. If the list of ready-queued tasks in the VM is not transparent for the hypervisor, with additional advantage the operating system in the VM can also report back to the hypervisor when no further task is ready to run. The hypervisor can then schedule another VM even though budget remains. Periodic activations are statically known and can be accounted for by the hypervisor. External sporadic activations are coordinated by the hypervisor. Active tasks within the VM are thus known to the hypervisor. This mechanism considerably increases the efficiency of the overall system as compared with conventional TDMA-based scheduling methods. It is advantageously possible in this context to conform to the same time guarantees. The static slack pools SP1, SP2 can at the same time, advantageously, increase the flexibility of the overall system guarantees.

In further embodiments of the present invention, implementation of the method according to preferred embodiments can be effected in both a global and a core-local scheduler.

A new scheduling decision can, for instance, (always) arise when a new task is ready for execution. This can be, for instance, a periodic or also an external interrupt-driven activation. Scheduling points can likewise be the exhaustion of budget RB, or the replenishment of budget RB, of a scheduling container C1, . . . , C5.

What is claimed is:

1. A computer-implemented method for planning computing-time resources of a computing device having at least one computing core or execution of tasks, comprising the following steps:
furnishing a plurality of containers, a priority being associated with each of the containers;
associating at least one of the tasks with at least one of the containers; and
associating each of the containers with the at least one computing core.

2. The method as recited in claim 1, wherein each of the containers has a respective static priority associated with it.

3. The method as recited in claim 1, wherein at least one of the containers has a resource budget associated with it, the resource budget characterizing computing-time resources for tasks associated with the container.

4. The method as recited in claim 1, wherein at least one of the containers has a budget replenishment strategy associated with it.

5. The method as recited in claim 3, wherein the at least one of the containers has a budget replenishment strategy associated with it, the budget replenishment strategy characterizing at least one of the following elements: a) a point in time of a replenishment of the resource budget associated with the container; b) an extent of the replenishment of the resource budget associated with the container.

6. The method as recited in claim 3, wherein the resource budget is replenished periodically and/or at static, specified points in time and/or depending on a previous consumption of computing-time resources associated with the resource budget.

7. The method as recited in claim 3, wherein the at least one of the containers has a budget retention strategy associated with it, the budget retention strategy characterizing a behavior of the container with regard to a resource budget that is not immediately used.

8. The method as recited in claim 7, wherein the budget retention strategy provides that a) the resource budget of the container expires at a or the point in time of a replenishment of the resource budget associated with the container provided no task is ready to use the resource budget associated with the container; and/or that b) the resource budget of the container continues to be reserved for tasks still arriving.

9. The method as recited in claim 1, further comprising the following steps:
ascertaining for each of the tasks that is ready, a respective first container having a not insignificant resource budget, to obtain first containers;
selecting one of the ascertained first containers having a highest priority to obtain a selected container such that when the selected container has been ascertained for several tasks, that task of the several tasks which has a highest priority is selected.

10. The method as recited in claim 1, wherein a corresponding task being ascertained for each of the at least one computing core and an execution of the corresponding task being carried out.

11. The method as recited in claim 1, wherein each of at least at least two of the containers being used as a static, slack pool, a container of the plurality of containers having a highest priority being used as a first slack pool, and/or a container of the plurality of the containers having a lowest priority being used as a second slack pool.

12. The method as recited in claim 11, wherein at least one of the tasks is associated a) with at least one of the containers other than the first slack pool, and b) additionally with the first slack pool.

13. The method as recited in claim 11, at least one of the tasks is associated a) with at least one of the containers other than the second slack pool, and b) additionally with the second slack pool.

14. The method as recited in claim 11, at least one tasks is associated only with the first slack pool or only with the second slack pool.

15. The method as recited in claim 11, wherein at least one of the tasks is associated with the first slack pool and with the second slack pool, and with at least one further one of the containers.

16. An apparatus for planning computing-time resources of a computing device having at least one computing core or execution of tasks, the apparatus configured to:
furnish a plurality of containers, a priority being associated with each of the containers;
associate at least one of the tasks with at least one of the containers; and
associate each of the containers with the at least one computing core.

17. A non-transitory computer-readable storage medium on which is stored instructions for planning computing-time resources of a computing device having at least one computing core or execution of tasks, the instructions, when executed by a computer, causing the computer to perform the following steps:
furnishing a plurality of containers, a priority being associated with each of the containers;
associating at least one of the tasks with at least one of the containers; and
associating each of the containers with the at least one computing core.

18. The method as recited in claim 1, wherein the computing-time resources are for an operating system for the computing device.

19. The method as recited in claim 1, wherein the computing-time resources are for a hypervisor for controlling virtual machines.
